(19) United States
(12) Patent Application Publication
(10) Pub. No.: US 2025/0139541 A1
(43) Pub. Date: May 1, 2025

(54) SYSTEMS AND METHODS FOR REARRANGING ICONS ON A GRAPHICAL USER INTERFACE

(71) Applicant: Fulcrum Global Technologies Inc., Chicago, IL (US)

(72) Inventors: Ahmed Farouk SHAABAN, South Barrington, IL (US); Venkat THANDRA, South Barrington, IL (US)

(21) Appl. No.: 19/004,096

(22) Filed: Dec. 27, 2024

Related U.S. Application Data
(63) Continuation of application No. 16/917,749, filed on Jun. 30, 2020.
(60) Provisional application No. 62/900,323, filed on Sep. 13, 2019.
(60) Provisional application No. 62/888,537, filed on Aug. 18, 2019.

(51) Int. Cl. G06Q 10/0631; G06Q 10/04; G06Q 10/1093

(52) U.S. Cl. CPC G06Q 10/063112; G06Q 10/04; G06Q 10/063118; G06Q 10/1097

(57) ABSTRACT

Systems and methods for rearranging icons on a graphical user interface are disclosed herein. In an embodiment, the method includes arranging a plurality of icons corresponding to a plurality of candidates on the graphical user interface, receiving a selection of a first candidate of the plurality of candidates from a user using the graphical user interface, determining, by a processor, an availability of the first candidate over a predetermined time period, and automatically rearranging the plurality of icons on the graphical user interface for selection of a second candidate based at least in part of the availability of the first candidate.

### PRIORITY

This patent application claims priority to U.S. Provisional Patent Application No. 62/888,537, filed Aug. 18, 2019, entitled “Team Formation Tool,” to U.S. Provisional Patent Application No. 62/900,323, filed Sep. 13, 2019, entitled “System for Allocating Professional Service Resources,” and to U.S. patent application Ser. No. 16/917,749, filed Jun. 30, 2020, entitled “System and Method for Optimizing Professional Services Resources Amongst a Plurality of Users,” the entirety of each of which is incorporated herein by reference and relied upon.

### BACKGROUND

### Technical Field

This disclosure generally relates to a system and method for optimizing professional services resources amongst a plurality of users. More specifically, the present disclosure relates to a system and method for optimizing the staffing of professional services professionals, for example, in law firm, business consultant, and medical practitioner environments.

### Background Information

In professional service businesses (e.g., law firms, business consultants, medical practices, etc.), it is often necessary to assemble a team of professionals to complete the work for a given matter. For example, in the context of a law firm, it is common for a given legal matter to require multiple associate attorneys, paralegals and other staff to work on the matter, often at the same time.

Often, when new legal matters are initiated, a law firm partner or the like is tasked with assembling a team of professionals to complete the work. Many times, this is done on an ad hoc and/or experiential basis, whereby the responsible partner has informal discussions with potential attorneys to staff the matter, during which discussions equally informal representations are often made as to the attorney's availability during the projected time required to complete the matter. These discussions are often initiated based on little more than the partner's familiarity with a given attorney, regardless of whether that attorney is a good fit for particular tasks presented by the matter in question or has enough time to complete the matter. Further, it is common for attorneys to over- or underestimate their availability to work on a particular matter within a given time frame. These factors, and others, frequently result in an inefficient process for staffing matters.

### SUMMARY

It has been discovered that tools for optimizing professional services resources are desired. A first aspect of the present disclosure is to provide a system for optimizing professional services resources. The system comprises a first user terminal, a second user terminal, and a central server. The first user terminal is configured to be controlled by a first user, the first user terminal including a first user input device configured to accept at least one matter input regarding a matter to be staffed for the first user. The second user terminal is configured to be controlled by a second user, the second user terminal including a second user input device configured to accept at least one user input from the second user. The central server is configured to communicate with the first user terminal and the second user terminal. The central server includes a processor and a memory, the processor configured to execute instructions stored on the memory to cause the central server to: (i) determine at least one matter input value based on the at least one matter input; (ii) determine at least one user input value based on the at least one user input; (iii) cause creation of a plurality of optimal candidates for the matter to be staffed based on a calculation using the at least one matter input value and at least one user input value; (iv) cause the plurality of optimal candidates to be displayed on the first user terminal to enable the first user to select among the plurality of optimal candidates; and (v) cause a candidate selected by the first user to be staffed on the matter.

In accordance with a second aspect of the present disclosure, which can be combined with the first aspect, the at least one matter input value is calculated based on a weight applied to the at least one matter input.

In accordance with a third aspect of the present disclosure, which can be combined with any one or more of the previous aspects, the at least one matter input value is calculated using a percentage of time available over a specified period.

In accordance with a fourth aspect of the present disclosure, which can be combined with any one or more of the previous aspects, the central server includes or is operatively connected to a database, and the calculation further includes use of historical data regarding the second user.

In accordance with a fifth aspect of the present disclosure, which can be combined with any one or more of the previous aspects, at least one of: (i) the at least one matter input value is calculated by the first user terminal; or (ii) the at least one user input is calculated by the second user terminal.

In accordance with a sixth aspect of the present disclosure, which can be combined with any one or more of the previous aspects, upon selection of a first candidate of the plurality of optimal candidates, the central server is configured to recalculate the at least one matter input value and cause a second plurality of optimal candidates to be displayed to the first user to enable the first user to select among the second plurality of optimal candidates using the first user terminal.

In accordance with a seventh aspect of the present disclosure, which can be combined with any one or more of the previous aspects, the at least one matter input value includes a first matter input value and a second matter input value, the first matter input value weighed more heavily than the second matter input value during the calculation.

In accordance with an eighth aspect of the present disclosure, which can be combined with any one or more of the previous aspects, the at least one user input value includes a first user input value and a second user input value, and the calculation results in the first user input value being weighed more heavily than the second user input value in causing creation of the plurality of optimal candidates.

In accordance with a ninth aspect of the present disclosure, which can be combined with any one or more of the previous aspects, a method for optimizing professional services resources includes determining at least one matter input value based on at least one matter input received from a first user terminal, the at least one matter input regarding a matter to be staffed, determining at least one user input value based on at least one user input received from a second user terminal, causing creation of a plurality of optimal candidates for the matter to be staffed based on a calculation using the at least one matter input value and the at least one user input value, enabling a selection, at the first user terminal, of at least one candidate of the plurality of optimal candidates, and staffing the selected candidate on the matter.

In accordance with a tenth aspect of the present disclosure, which can be combined with any one or more of the previous aspects, the method includes calculating the at least one matter input value based on a weight applied to the at least one matter input.

In accordance with an eleventh aspect of the present disclosure, which can be combined with any one or more of the previous aspects, the method includes calculating the at least one matter input value using a percentage of time available over a specified period.

In accordance with a twelfth aspect of the present disclosure, which can be combined with any one or more of the previous aspects, the method includes accessing historical data stored in a database and including the historical data in the calculation using the at least one matter input and the at least one user input.

In accordance with a thirteenth aspect of the present disclosure, which can be combined with any one or more of the previous aspects, the method includes recalculating the at least one matter input value upon selection of a first candidate, and causing a second plurality of optimal candidates to be displayed on the first user terminal to enable a second selection among the second plurality of optimal candidates.

In accordance with a fourteenth aspect of the present disclosure, which can be combined with any one or more of the previous aspects, the at least one matter input value includes a first matter input value and a second matter input value, and the method includes weighing the first matter input value more heavily than the second matter input value during the calculation.

In accordance with a fifteenth aspect of the present disclosure, which can be combined with any one or more of the previous aspects, the at least one user input value includes a first user input value and a second user input value, and the method includes weighing the first user input value more heavily than the second user input value in determining the plurality of optimal candidates.

In accordance with a sixteenth aspect of the present disclosure, which can be combined with any one or more of the previous aspects, a method of assembling an optimal team of professional resources providers includes receiving a request regarding a matter to be staffed, the request including at least one matter input determined by a first user, calculating at least one matter input value using the at least one matter input, causing creation of a first plurality of optimal candidates for the matter to be staffed based on the calculation, staffing a first candidate of the first plurality of optimal candidates to the matter, recalculating the at least one matter input value using information regarding the first candidate, causing creation of a second plurality of optimal candidates for the matter to be staffed based on the recalculation, and staffing a second candidate of the second plurality of optimal candidates to the matter.

In accordance with a seventeenth aspect of the present disclosure, which can be combined with any one or more of the previous aspects, recalculating the at least one matter input value includes recalculating a percentage of time needed for the matter over a specified period.

In accordance with a eighteenth aspect of the present disclosure, which can be combined with any one or more of the previous aspects, the method includes receiving a second matter input from the user after staffing the first candidate, and using the second matter input during recalculation of the at least one matter input value.

In accordance with a nineteenth aspect of the present disclosure, which can be combined with any one or more of the previous aspects, the at least one matter input value includes a first matter input value and a second matter input value, and the method includes weighing the first matter input value more heavily than the second matter input value during the calculation

In accordance with a twentieth aspect of the present disclosure, which can be combined with any one or more of the previous aspects, the method further includes weighing the second matter input value more heavily than the first matter input value during the recalculation.

### BRIEF DESCRIPTION OF THE DRAWINGS

Referring now to the attached drawings which form a part of this original disclosure:

FIG. 1 illustrates an example embodiment of a system for optimizing professional services amongst a plurality of users according to the present disclosure;

FIG. 2 is a representative diagram of an example embodiment of a user terminal which can be used in the system of FIG. 1;

FIG. 3 is a representative diagram of the system for optimizing professional services amongst a plurality of users shown in FIG. 1;

FIG. 4 illustrates an example embodiment of a database building method according to the present disclosure;

FIG. 5 illustrates an example embodiment of a method for optimizing professional services according to the present disclosure;

FIG. 6 illustrates another example embodiment of a method for optimizing professional services according to the present disclosure;

FIG. 7 illustrates an example embodiment of a method for reviewing and/or editing existing matters in accordance with the present disclosure; and

FIGS. 8 to 15 are screen shots of various examples of user interface screens which can be displayed during various embodiments of the present disclosure.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

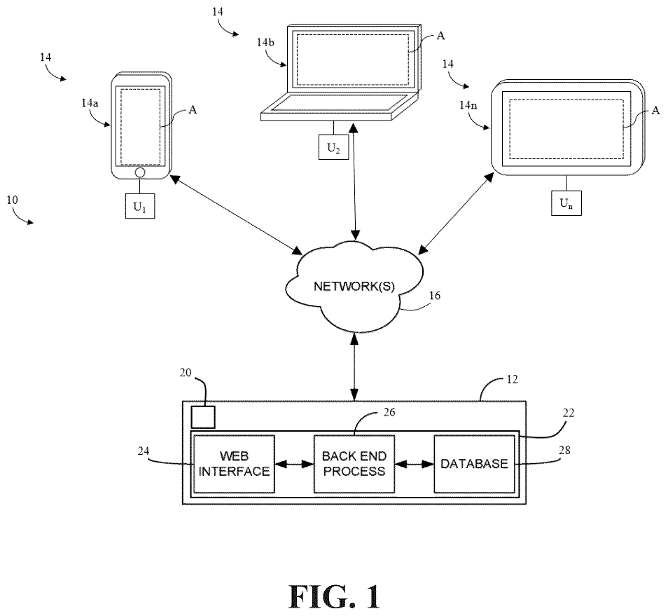

FIG. 1 illustrates an example embodiment of a system 10 for optimizing professional services amongst a plurality of users. In the illustrated embodiment, the system 10 includes a central server 12 and a plurality of user terminals 14 operated by a plurality of users U₁, U₂ . . . Uₙ. In use, the central server 12 can wirelessly communicate with each of the user terminals 14 via a network 16 to optimize the use of professional services provided by the plurality of users U₁, U₂ . . . Uₙ.

Each of the plurality of user terminals 14 can be, for example, a cellular phone, tablet, personal computer, or other electronic device. Here, the plurality of user terminals 14 includes a first user terminal 14a, a second user terminal 14b, and an nth user terminal 14n. Each user terminal 14 can be controlled by a distinct user U₁, U₂ . . . Uₙ (e.g., a first user U₁ controls the first user terminal 14a, a second user U₂ controls the second user terminal 14b, and an nth user Uₙ controls the nth user terminal 14n). The user U₁, U₂ . . . Uₙ of each user terminal 14 can be, for example, an individual person seeking to establish a team of professionals to staff a given matter, and/or a professional that can be identified as a potential team member for a given matter.

The user terminals 14 can communicate with the central server 12 via various communication protocols, for example, via an Internet Protocol Suite or TCP/IP supporting HTTP. The network 16 can comprise a public network (e.g., the Internet, World Wide Web, etc.), a private network (e.g., local area network (LAN), etc.), and/or combinations thereof (e.g., a virtual private network, LAN connected to the Internet, etc.). The network 16 can include a wired network, a wireless network, and/or a combination of the two.

The central server 12 can comprise one or more server computers, database servers and/or other types of computing devices, particularly in connection with, for example, the implementation of websites and/or enterprise software. The central server 12 can further comprise a central processor 20 and a central memory 22. The central processor 20 is configured to execute instructions programmed into and/or stored by the central memory 22. As described in more detail below, many of the steps of the methods described herein can be stored as instructions in the central memory 22 and executed by the central processor 20.

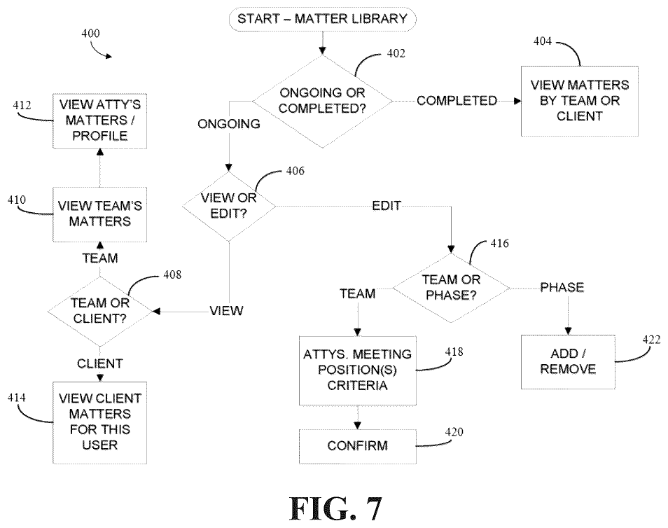

In the illustrated embodiment, the central memory 22 can comprise a web interface 24, a database 26, and a back end process 28. Here, the web interface 24, database 26 and back end process 28 can be controlled or accessed by the central processor 20 implementing appropriate software programs by executing instructions programmed into and/or stored by the central memory 22. For example, in an embodiment, the web interface 24 and back end process 28 can be implemented using the Django web framework, and the database 26 can be implemented using the PostgreSQL relational database management system (RDBMS). The web interface 24 operates to provide a graphical user interface 25 (GUI 25) that can be displayed on a user terminal 14 for a user. For example, in the case of users seeking to staff a matter, various interfaces can illustrate information about professionals including their availability. In another example, in the case of professionals that can be added to a given team, various interfaces can permit users to review their various currently-assigned and prospectively-assigned matters. An example embodiment of a method of navigating and/or updating interfaces is illustrated at FIG. 7.

In an embodiment, each user terminal 14 can include an application A comprising software downloaded to and executed by the user terminal 14 to provide the graphical user interface 25 and to manage communications with the central server 12. The application A can be downloaded to the user terminal 14 from the central server 12 or from some other source such as an application distribution platform.

In addition to user credentials and similar data necessary to implement a web-based service, the database 26 can store all data required to ascertain each associate's capabilities (e.g., skills, past experiences, etc.), ongoing representation in various matters (current assignments) as well as time entry data. The stored data can include, for example, the user inputs described herein and/or user feedback from third parties.

As illustrated, the back end process 28 can be operatively coupled to both the web interface 24 and the database 26. The back end process 28, which can be implemented by the central processor 20 executing instructions programmed into and/or stored by the central memory 22, directs operations of the central server 12 as described below in further detail. For example, the back end process 28 can determine associate availability through the calculation of user input values based on time entry data and/or other inputs provided directly by the relevant associates. The back end process 28 can further operate to implement various searching functions such that partners can more efficiently identify suitable associates for inclusion on a team.

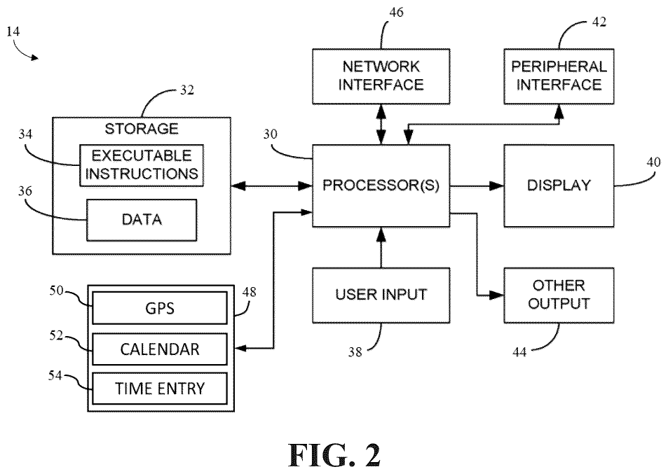

FIG. 2 illustrates a representative diagram of an example embodiment of a user terminal 14. As illustrated, a user terminal 14 can include a terminal processor 30 and a terminal memory 32. The terminal processor 30 is configured to execute user instructions programmed into and/or stored by the terminal memory 32. The user instructions can be received from and/or periodically updated by the central server 12 in accordance with the methods discussed below. As described in more detail below, many of the steps of the methods described herein can be stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored user instructions 34 and operating upon stored user data 36, wherein the user instructions 34 and/or stored user data 36 are stored by the terminal memory 32. Likewise, the terminal memory 32 can comprise one or more devices such as volatile or nonvolatile memory, for example, random access memory (RAM) or read only memory (ROM). Further still, the terminal memory 32 can be embodied in a variety of forms, such as a hard drive, optical disc drive, floppy disc drive, etc. In an embodiment, many of the processing techniques described herein are implemented as a combination of executable instructions 34 and data 36 within the terminal memory 32.

As illustrated, each of the plurality of user terminals 14 includes one or more user input device 38, a display 40, a peripheral interface 42, one or more other output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or any other input source used as described herein. Likewise, the other output device 44 can optionally include similar media drive mechanisms, other processing devices or other output destinations capable of providing information to a user of the user terminal 14, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

In various embodiments discussed herein, the user terminal 14 can include one or more other tracking devices 48 configured to track and/or periodically gather user data 36 regarding the user of the user terminal 14. The tracking devices can include, for example, a global positioning system (“GPS”) device 50, a digital calendar 52, a time entry program 54, and/or other terminal-specific devices which track movements and/or data usage by the user of the user terminal 14. The GPS device can be used, for example, to record past or present data regarding the location of the user terminal. The digital calendar 52 can be used, for example, to record past, present, or future data regarding the user's various matter responsibilities. The time entry program 54 can be used, for example, to determine a user's current progress with respect to a current or future matter being worked on by determining an amount of time already recorded as being completed with respect to the matter.

While the user terminal 14 has been described as one form for implementing the techniques described herein, those having ordinary skill in the art will appreciate from this disclosure that other functionally equivalent techniques can be employed. For example, as known in the art, some or all of the functionality implemented via executable instructions can also be implemented using firmware and/or hardware devices such as application specific integrated circuits (ASICs), programmable logic arrays, state machines, etc. Further, other implementations of the user terminal 14 can include a greater or lesser numbers of components than those illustrated. Further still, although a single user terminal 14 is illustrated in FIG. 2, it should be understood from this disclosure that a combination of such devices can be configured to operate in conjunction (for example, using known networking techniques) to implement the methods described herein.

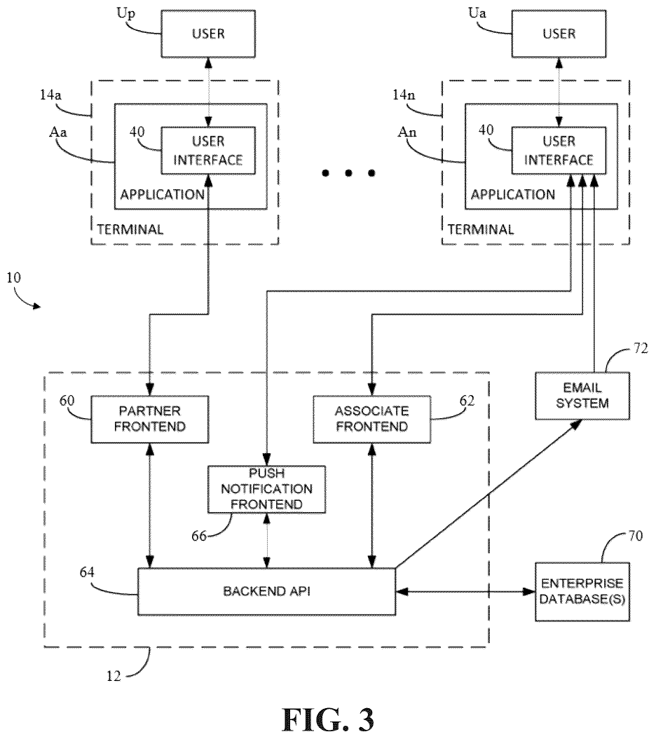

In an embodiment, the system 10 illustrated in FIGS. 1 and 2 functions as a tool to assist users U₁, U₂ . . . Uₙ in the allocation of professional service resources, for example, permitting law firm partners to search for qualified, available associates and staff those associates on appropriate matters. A more detailed implementation of system 10 is further illustrated in FIG. 3, which is a functional block diagram of structure for implementing the system 10 in accordance with the instant disclosure. By using the system 10 in accordance with the techniques described herein, a matter can be staffed quickly and effectively by qualified candidates.

Referring to FIG. 3, a plurality of terminals 14 as described above is illustrated (only two shown for ease of illustration). Each of the terminals 14a, 14n implements an application Aa, An, which in turn implements a graphical user interface 25 on the display 40, thereby allowing a plurality of users to interact with the central server 12. In an embodiment, the users can include associates (illustrated in FIG. 3 as user Uₐ) who are available for assignment to matters/teams via the system 10, and partners (illustrated in FIG. 3 as user Up) who can search the availability of associates, request creation of optimal candidates for particular matters, and form teams for the matters via the system 10. It should be understood that the terms “partner” and “associate” are not used herein in a restrictive sense, and that a “partner” can refer to anyone seeking to assemble a team of professional service providers, and an “associate” can be any level of professional service provider that is capable of being assigned to a team with the context of a given use case. Typically, the associates and partners are all employees of a given enterprise, though this not a requirement. For example, an associate can be someone outside of the enterprise, e.g., a contract attorney or the like.

In an embodiment, access to the system 10 provided to associates permits them to perform various tasks, e.g., to view their own assignments, view and update their personal information, view the contact information of partners they are working with, view information for other individuals within the enterprise, and input scheduling conflicts. In an embodiment, the associates can also search for other individuals within their firm. In an embodiment, the partners (which can also include system administrators, and other managing roles in the enterprise) are able to perform the functions available to the associates and are further allowed to staff matters with available associates and view the matters that associates are working on.

As shown, the central server 12 can implement several operational components. For example, the web interface 24 can be used to implement various frontend 60, 62 functions. In accordance with the two sets of users (e.g., partners and associates), there are separate interfaces, a partner frontend 60 and associate frontend 60 for performing various ones of the functions described herein in conjunction with the backend application programming interface (“API”) 64. For example, the partner frontend 60 can implement interfaces that allow partners to determine associate availability, filter through associates based on input criteria and assign associates to matters. On the other hand, the associate frontend 62 can implement interfaces that allow associates to view their respective matter assignments, any projected lengths of time for assigned matters (i.e., expected matter durations, where possible) and input data concerning potential scheduling conflicts in the future. An example embodiment of a method of navigating and/or updating interfaces is illustrated at FIG. 7.

Further, in an embodiment, the associates can be presented with a weekly push notification, via a push notification frontend 66, that prompts associates to indicate their availability. For example, in the law firm context, associates are typically required to submit time entries on at least a weekly basis, if not more frequently. Given this, notifications provided by the push notification frontend 66 can be tied into the firm's time entry system (not depicted in FIG. 3) such that each associate is prohibited from entering his/her time entries using the time entry program 54 until they respond to their weekly push notification by indicating/updating their upcoming availability. For instance, in this embodiment, the push notification frontend 66 can be designed as a wrapper around the time-keeping system that gets launched by default when the time-keeping system in invoked by an associate. This resulting push notification will ask the associate to mark themselves as available or unavailable for work over the course of short-term and long-term periods, which periods can be determined as a matter of design choice. This availability information can subsequently be cross-referenced with predictions of the associate's availability provided by the backend API 64 as a check for prediction accuracy.

The database 28 can implement one or more enterprise databases 70 provided by the enterprise. For example, such enterprise databases 70 can include data concerning previous matters worked on by professionals within the enterprise, as well as information (on a per matter basis) concerning the corresponding client, time entry information for a matter, the various phases for such matters and other relevant criteria. In an embodiment, this information allows the backend API 64 to predict associate availability based on similar matters that have been previously staffed that match similar criteria. For example, in the example of a wrongful discharge lawsuit to be tried in the Northern District of Illinois, the backend API 64 can identify similar matters having matching criteria (wrongful discharge lawsuit, N.D. Ill., etc.) and thereby identify those attorneys used to staff those prior matters, which attorneys can then serve as the basis for a future availability determination. Further still, the enterprise databases 70 can include the enterprise's human resources database to obtain data concerning each associate's background, subject matter expertise, qualifications, recognition, location, language speaking abilities and/or any other data that allows partners to filter for requisite traits when searching for individuals to staff a matter.

In an embodiment, the back end process 26 can implement a backend API 64 that implements management logic necessary to operate the frontends 60, 62. Accordingly, the backend API 64 can provide relevant data to the frontends 60, 62 preferably, for example, via a REST API as known in the art. In an embodiment, the backend API 64 can operate to pull relevant information from the enterprise databases 70 and calculate confidence intervals of associate availability based on the comparison of their current matter assignments to previous matters. In an embodiment, the availability determination operates in a layered system, whereby various predictive techniques are employed based on the available information about a given matter and timekeeper. Thus, availability prediction can start with the most accurate method of prediction (as determined by past experience) based on the suitability of the available information relative to that method or its applicability. If the most accurate method is unavailable for use, progressively less accurate methods can be employed, once again based on the available information and applicability thereof. For example, a first predictive technique can rely on finding like matters to the one in question, where a like matter is one that has a similar definition for at least the first few phases of the matter. Using the like matter, the progression for the new matter can be modeled and predicted for that timekeeper. Alternatively, for the phases of a matter that an attorney does most often, if they have already completed a current matter, the attorney is marked done for that matter. If the attorney is currently working on a particular phase, a prediction is provided that the attorney will be done with that phase by the upper limit of the confidence interval for that phase (95%). If the attorney's efforts have already gone past that bound, the prediction is augmented by adding hours proportional to how many hours over prediction the previous phases in that matter have been. Further still, if neither of these prior techniques is applicable, a short-term prediction can be based on extrapolation of any trend of the attorney's hours per day on each relevant matter.

In an embodiment, the backend API 64 can operate to provide filters according to associate traits available in a human resources database. As illustrated below, these filter options can be presented to partners via the partner frontend 60 when searching for an available associate. Once a partner has enrolled a matter and staffed it with associates found through the search function, the backend API 64 writes this information to the enterprise database 70 of matters so that the matter and associate assignments are properly recorded.

Further still, the backend API 64 can store associate inputs to the push notifications (as described above) in the enterprise database 70 for accounting metrics as well as compare their response with the availability prediction determined by the backend API 64. If the associate's response and prediction align, no action is required. If the backend API 64 predicts the associate is unavailable but the associate responds to the push notification as being available, the associate's response overrides the prediction such that the associate will be shown as having availability in any subsequent searches. Likewise, if the associate responds to the push notification as being unavailable and the backend API 64 predicts that the associate should be available, the associate's response overrides the backend API 64 prediction. In an embodiment, an associate's responses will be stored and available to management, which is particularly useful as an auditing basis if an associate continuously marks him/herself as unavailable but is not otherwise meeting performance expectations, such as meeting billable requirements.

In an embodiment, the backend API 64 also interfaces with an email system 72 to implement communications with individual users U₁, U₂ . . . Uₙ. Consequently, when a partner has staffed a matter through the system 10, the backend API 64 causes an email to be sent to all associates who have been added to the matter. In an embodiment, the email includes a link that will take them directly to a matter page (as described below), which can also be found by logging into their account and viewing the matter to which they are assigned. From this new matter page, the associate has the ability to input any conflicts, scheduling or otherwise, that will prevent them from working on this matter allowing the partner to reassign their role to another associate.

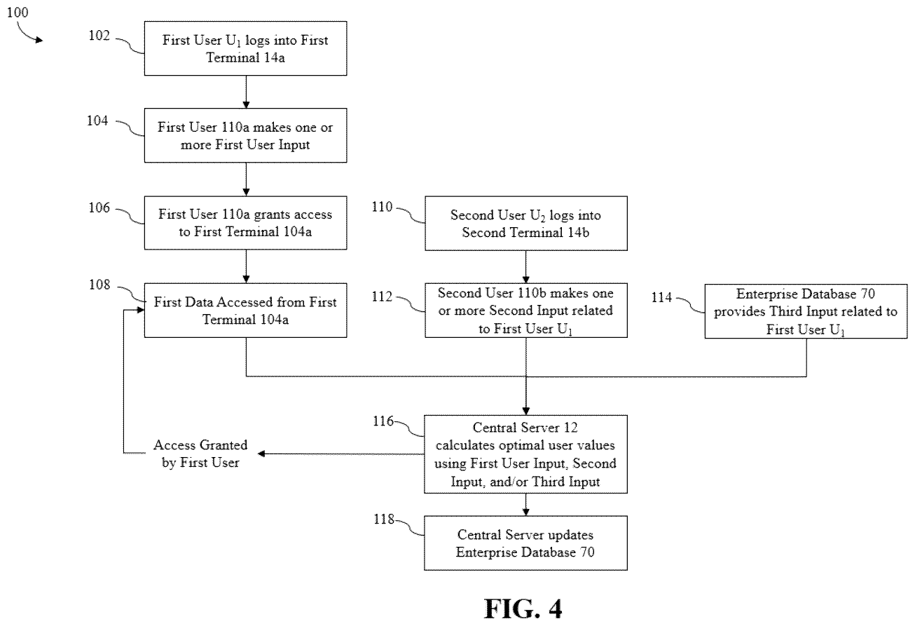

FIG. 4 illustrates an example embodiment of a database building method 100 according to the present disclosure. Some or all of the steps of method 100 can be stored as instructions on the central memory 22 and/or one or more terminal memory 32 and can be executed by the central processor 20 and/or one or more terminal processor 30 in accordance with the respective instructions stored on the central memory 22 and/or one or more terminal memory 32. It should be understood that some of the steps described herein can be reordered or omitted without departing from the spirit or scope of method 100.

At step 102, a first user U₁ logs into a user terminal 14, here a first user terminal 14a. The first user terminal 14a can be, for example, the first user's cellular phone, tablet, personal computer or other electronic device. The first user terminal 14a can have user processing instructions 34 already saved on a terminal memory 32 after having been previously received from the central server 12, or the first user terminal 14a can communicate with the central server 12 to receive up-to-date user processing instructions 34 which can then be saved on the terminal memory 32. The user processing instructions 34 saved on the terminal memory 32 can then be executed by the terminal processor 30. The user processing instructions 34 can include, for example, instructions which cause the first user terminal 14a to request, process and/or save certain user data 36 to be transmitted to the central server 12 for further processing.

At step 104, the first user U₁ enters one or more first user input into the first user terminal 14a using the user input device 34. The first user input can include, for example, the first user's name or identification number, the first user's practice specialty or multiple practice specialties, the first user's current or future location, the first user's preferred working days or hours, the first user's current availability, the first user's willingness to travel to certain locations, and/or other types of user inputs. Additionally, the first user U₁ input can include weighting factors which allow the user to identify preferences and/or weight the first user inputs. For example, the first user U₁ may prefer to work in a single location regardless of the working hours, in which case the user can indicate a preference for location over working certain days or hours. Alternatively, the first user may only be willing to work certain days, but may be willing to travel anywhere, in which case the user can indicate a preference for certain days over traveling to certain locations.

In an embodiment, the first user input can include a user's time entry for an existing matter that the user is already working on. In this way, the user's availability can be determined at the user terminal 14 or at the central server 12 based on how much additional time the user is expected to spend on the existing matter. For example, if a user is expected to spend 40 hours on an existing matter during a particular time period, and the user's time entry brings the user's total time to 30 hours for the existing matter for that time period, then user's availability can be determined based on the remaining 10 hours that the user is expected to still spend on that matter. In an embodiment, the user's time entries can be made, for example, using time entry program 54 of user terminal 14.

In an embodiment, one or more user input value (UIV) can be determined using the user inputs. The user input value can be calculated, for example, based on a percentage of time available during a specific period of time. Such a user input value can be calculated, for example, using a user input from the user's digital calendar 52 or time entry program 54. In an embodiment, the user input value can be calculated based on the user's current time entries, for example, by determining how much time a user has already spent on an existing matter and/or by calculating that the user is unavailable for an amount of time still expected to be spent on the existing matter. In an embodiment, the time expected to be spent on the existing matter can be calculated from a predetermined total value entered for the existing matter, from past similar matters, or from the particular user's past experience.

In another example embodiment, one or more user input value can be calculated such that 0≤UIV≤1. For example, an indispensable element can be calculated as 1, an unimportant element can be calculated as 0, and a preferred or desired but not indispensable element can be calculated to be between 0 and 1. Those of ordinary skill in the art will recognize alternative ways to calculate user input values and/or alternative scaling that can be used. By calculating user input values in this manner, the system 10 disclosed herein is able to improve processing speed when determining an optimal candidate and reduce storage space for items related to the matter. The user input values can be calculated by the user terminal 14 prior to transmission to the central server 12, or can be calculated at the central server 12 using the user input received at the user terminal 14 and/or other inputs as discussed below.

At step 106, the first user U₁ can grant access for the central server 12 to continuously or intermittently access various features of the first user terminal 14a. In one embodiment, the first user U₁ can grant unlimited access to any user terminal feature or tracking device 48 desired by the central server 12. In another embodiment, the first user U₁ can grant access to only specific features or tracking devices 48 of the first user terminal 14a. Tracking devices 48 of the first user terminal 14a include, for example, a GPS device 50, a digital calendar 52, a time entry program 54, and/or other terminal-specific devices which track movements and/or data of the first user U₁ of the first user terminal 14a. Some user terminals 14 can have more or less features available than other user terminals 14. If access is granted, the terminal processor 30 can continuously or intermittently pull user data from one or more terminal feature or tracking device 48 and store the data as user data 36 for transmission to the central server 12.

In an embodiment, the first user U₁ can grant access to one or more social media accounts, wherein user input data regarding the user's personal interests can be gathered to later match the candidates to clients or other users with similar interests.

At step 108, based on the access granted by the first user U₁, certain first user granted data can be gathered and stored as user data 36. For example, if the user allows access to the GPS device 50 of the first user terminal 14a, then GPS data detected by the GPS device 50 can be gathered by the first user terminal 14a and stored as user data 36. If the user allows access to the digital calendar 52 of the first user terminal 14a, then calendar data regarding the first user's upcoming schedule can be gathered by the first user terminal 14a and stored as user data 36. If the user allows access to the time entry program 54 of the first user terminal 14a, then timing data regarding time spent on previous or current matters can be gathered by the first user terminal 14a and stored as user data 36. In an embodiment, the first user granted data can be combined with the first user inputs and saved as user data 36, and the user data 36 can be transmitted to the central database 12 via a data packet. In an embodiment, one or more user input value can be determined at step 108 using one or more of the first user inputs, the first user granted data, and/or the combined user data. Alternatively, the user input values can be determined at central server 12 after transmitting the data packet to the central server. In an embodiment, by calculating user input values at the user terminal 14 prior to transmission, the system 10 disclosed herein is able to improve processing speed and save memory space at the central server 12 when causing creation of a plurality of optimal candidates as described herein.

At step 110, a second user U₂ separately logs into a user terminal 14, here a second user terminal 14b. The second user U₂ can be, for example, someone who knows or has worked with the first user U₁ or an outside party who has had work performed by the first user U₁. The second user terminal 14b can be, for example, the second user's cellular phone, tablet, personal computer or other electronic device. The second user terminal 14b can have user processing instructions 34 already saved on a terminal memory 32 after having been previously received from the central server 12, or the second user terminal 14b can communicate with the central server 12 to receive up-to-date user processing instructions 34 which can then be saved on the terminal memory 32. The user processing instructions saved on the terminal memory 32 can then be executed by the terminal processor 30. The user processing instructions 34 can include, for example, instructions which cause the second user terminal 14b to request certain second input regarding the first user U₁ to be transmitted to the central server 12 for further processing.

At step 112, the second user U₂ makes one or more second input regarding the first user U₁. For example, the second input can be related to specific matters performed by the first user U₁ for or on behalf of the second user U₂. The second input can include information regarding the specialty of the first user U₁, specific tasks performed by the first user for or on behalf of the second user U₂, ratings for the first user U₁ regarding the specific tasks, ratings regarding the first user U₁'s availability during performance of the specific tasks, and/or other information relevant to determining the first user U₁'s ability to perform similar tasks. In one embodiment, the second user U₂ is a partner who has previously had work completed by the first user U₁ and is entering the second inputs based on the work completed. In another embodiment, the second user U₂ is a third party who has previously had work completed by the first user U₁ and is entering the second inputs based on the work completed.

At step 114, the enterprise database 70 provides one or more third input related to the first user U₁. The third input can be related to historical data regarding past matters performed by the first user U₁. For example, the third input can include previous ratings applied to the first user U₁ for past matter, previous amounts of time billed to the past matter, and/or previous details of the past matter such as where the past matter was completed, when the past matter was completed, who else was involved in the past matter, or what specialty the first user U₁ performed in the past matter. In an embodiment, the historical data can include amounts of time previously spent on past matters which can be later used in accordance with the methods herein to predict a time of completion for future matters.

At step 116, the central server 12 receives one or more of the first user input, the second input, and/or the third input. The central server 12 can then calculate updated user input values based on the first user input, the second input, and/or the third input. The updated user input values can include, for example, information related to the first user's practice specialty or multiple practice specialties, the first user's current or future location, the first user's preferred working days or hours, the first user's current availability, the first user's willingness to travel to certain locations, and/or other types of user information. If the first user U₁ has granted repeated access to all or certain types of user granted data, then the central server 12 can periodically request updated data packets from the first user terminal 14a and repeatedly recalculate updated user input values using the user granted data. In this way, the central server 12 can build an up-to-date database 28. In an alternative embodiment, the first user U₁ can push updated data packets to the central server 12 at the user's discretion.

In an embodiment, the central server 12 can calculate one or more updated user input value using the first user U₁'s schedule (e.g., from digital calendar 52) in combination with historical data from enterprise database 70 related to previous amounts of time billed to one or more past matters and/or current data from the user's time entry program 54. In this way, the central server 12 can calculate the first user U₁'s availability for different matters, wherein one type of matter can take longer than another type of matter based on the user's past performance, thus allowing the user's availability for some types of matters to be different for other types of matters. Here, the central server 12 can calculate a first user input value for a first matter, a second user input value for a second matter, etc. For example, this can result in the user having 100% availability for certain requests, but only 50% availability for other types of requests.

At step 118, the central server 12 updates the enterprise database 70 with the calculated updated user input values and other information which can be used to staff the first user U₁ in accordance with the methods discussed herein. Method 100 can thereafter be repeated for any number of users who wish to be made available for staffing in accordance with the methods discussed herein. By calculating updated user values as described herein and storing the updated user input values in a database, the processing speed can be improved and memory storage can be saved when these updated user input values are later used to staff matters.

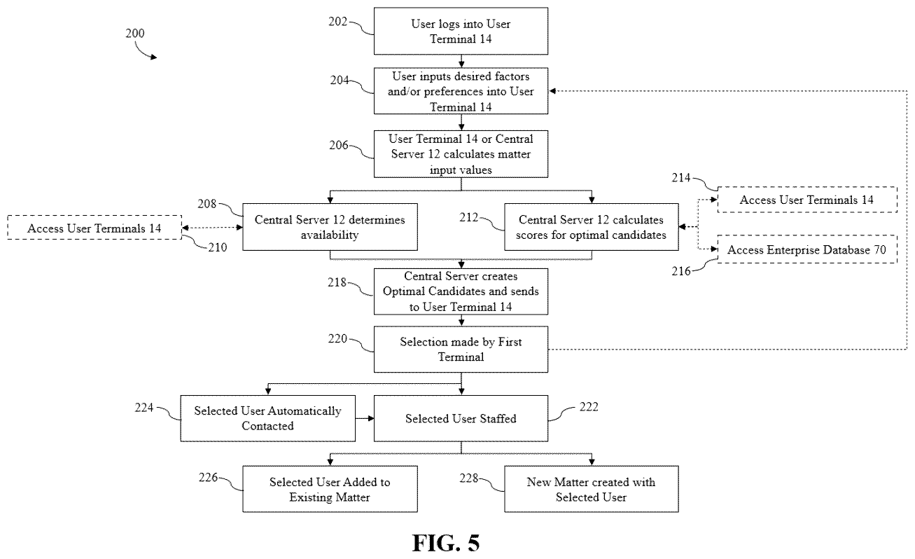

FIG. 5 illustrates an example embodiment of a method 200 for optimizing professional services using the database built from the database building method 100 of FIG. 4. Some or all of the steps of method 200 can be stored as instructions on the central memory 22 and/or one or more terminal memory 32 and can be executed by the central processor 20 and/or one or more terminal processor 30 in accordance with the respective instructions stored on the central memory 22 and/or one or more terminal memory 32. It should be understood that some of the steps described herein can be reordered or omitted without departing from the spirit or scope of method 200. In an embodiment, method 200 can be used, for example, to perform a search for an attorney by a partner seeking to staff a new matter.

At step 202, an organizational user (e.g., a partner) seeking to staff a matter logs into a user terminal 14. The organizational user can be the first user U₁ or the second user U₂ previously discussed herein, or can be a new user. The matter needing to be staffed can be an entire project, a specific phase of a project, or multiple phases of a project. Likewise, the user terminal 14 can be the first terminal 14a or the second terminal 14b previously discussed herein, or can be a new user terminal 14. The user terminal 14 can be, for example, a cellular phone, tablet, personal computer, or other electronic device. The user terminal 14 can have user processing instructions 34 saved on a terminal memory 32, or can communicate with the central server 12 to receive user processing instructions 34 which can be executed by the terminal processor 30. The user processing instructions 34 can include, for example, instructions which enable the user terminal 14 to accept various matter inputs regarding the organizational user's needs for staffing the matter.

At step 204, the organizational user inputs one or more matter inputs into the user terminal 14 using the user input 34 and/or display 40. The matter inputs can include, for example, a type of work desired, a location of work desired, a number of hours desired, a range of billing rates desired, language speaking abilities, and/or other keywords. The one or more matter inputs can also include, for example, weighting factors which allow the organizational user to input preferences and/or weight the matter inputs. For example, the organizational user can require a specific specialty regardless of location, or can require a specific location, number of hours, or certain days available. In an embodiment, all matter inputs can be weighed equally by a default setting unless the organizational user specifies that one matter input is more important than another matter input.

In an embodiment, step 204 involves a law firm partner providing matter inputs concerning specific availability and/or other criteria for a particular associate position they would like to fill for a given matter. In this case, the availability criteria can be expressed as a window of time during which the associate would need to be available, and/or an anticipated percentage of the associate's time that would be required during that window of time. Likewise, the other criteria can be based on any of a number of searchable attributes for associates, e.g., by the associate's title, practice group, office/location, billing rate, language speaking abilities, and/or keywords.

At step 206, the user terminal 14 and/or central server 12 determines one or more matter input value (MIV) using the one or more matter inputs entered at step 204. The matter input values can be calculated, for example, by taking into account both the type of work desired and the importance of various factors regarding the work. In an example embodiment, one or more matter input value can be calculated based on a percentage of time available during a specific period of time. For example, a matter input value can be calculated as signifying a request for 50% of an associate's time over a specific two-week period (e.g., 40 hours over two weeks based on an 80 hour workweek).

The matter input values can also be calculated in other ways. In another example embodiment, one or more matter input value (MIV) can be calculated such that 0≤MIV≤1. For example, an indispensable element can be calculated as 1, an unimportant element can be calculated as 0, and a preferred or desired but not indispensable element can be calculated to be between 0 and 1. Those of ordinary skill in the art will recognize alternative ways to calculate matter input values and/or alternative scaling that can be used. By calculating matter input values in this manner, the system 10 disclosed herein is able to improve processing speed when determining an optimal candidate and reduce storage space for items related to the matter.

In another embodiment, the matter input values can be calculated based on ratings or specific needs regarding practice specialty, current or future locations, preferred working days or hours, current availability, willingness to travel to certain locations, language speaking abilities, and/or other types of information relevant to a specific matter. In an embodiment, a single matter input value can be calculated for each rating or specific need, or multiple matter input values can be calculated for each rating or specific need.

At step 208, the central database 12 determines the availability of a preliminary group of associates appearing to fit the user's desired criteria, for example, by meeting or exceeding the calculated matter input value for availability. In an embodiment, the central server 12 can first compile a preliminary group of candidates who appear satisfy at least one of the matter inputs regarding availability inputted by the user at step 204. In another embodiment, the central server 12 can compile the preliminary group of candidates, for example, using the matter input values calculated at step 206 by favoring the candidates determined to have the highest corresponding matter input value(s). In an embodiment, the central server can calculate the candidate's suitability to be available using the matter input value determined at step 206 and a previously determined user input value.

In an embodiment, the central database 12 can access the user terminals 14 of the preliminary group of candidates at step 210 to determine each candidate's availability to work on the matter desired by the organizational user. Specifically, the central database 12 can access features of the user terminal such as the GPS device 50, the digital calendar 52, the time entry program 54, and/or other terminal-specific devices which track movements and/or data usage of the terminal 14. For example, the central database 12 can confirm a candidate's location using the GPS device 50 and/or a user input value calculated from data from the GPS device 50. Likewise, the central database 12 can confirm the candidate's availability over a specific period of time or the candidate's ability to dedicate a specific number of hours over a specific time by accessing the candidate's digital calendar 52 and/or a user input value calculated from data from the candidate's digital calendar 52. The central database 12 can further calculate the candidate's available time using time entry program 54 and/or a user input value calculated from data from the candidate's time entry program 54, for example, by determining how much time the candidate has remaining with a matter currently being performed. For example, if the candidate is currently working on a matter during a specified time period which is expected to take a certain number of hours (e.g., 40 hours), the central database can determine the amount of time already billed to that matter (e.g., 20 hours) and determine the amount of remaining time the user will need to complete that matter (e.g., another 20 hours), thus determining the candidate's availability during that time period. Using the data received from the user terminals 14, the central database 12 can then eliminate one or more candidate of the preliminary group of candidates who cannot satisfy the organizational user's needs for the new matter being staffed, for example, for not meeting or exceeding a calculated matter input value regarding availability. Additionally, the central database 12 can break the matter down into separate phases to determine availability.

At step 212, the central database 12 calculates optimal values for the optimal candidates to fill the organizational user's needs for staffing the matter. The optimal values can be calculated, for example, by calculating an optimal matter score based on the candidate's specialty and/or the needs of the user staffing the matter. For example, the central database 12 can calculate an optimal score for each of a plurality of possible candidates, which can include the first user U₁ and other users who have completed the method of 100. In an embodiment, the central processor 20 calculates a plurality of optimal matter scores using one or more of the matter inputs determined at step 204, the matter input values (MIV's) calculated at step 206, and/or the user input values (UIV's) (e.g., the user input values and/or updated user input values) calculated during the database building method 100. In an embodiment, the central processor 20 can calculate each optimal matter score using the following equation:

$${S}_{OM} = \frac{\begin{matrix}( M IV 1 \times UIV 1 ) + \\ ( MIV 2 \times UIV 2 ) + … ( MIVn \times UIVn )\end{matrix}}{( total inputs )} \qquad ( Equation l )$$

In equation 1, MIV1 is a matter input value corresponding to a first user input value UIV1, MIV2 is a matter input value corresponding to a second user input value UIV2, and MIVn is a matter input value corresponding to an nth user input value UIVn. In this way, central database 12 can weigh both the preferences of the organizational user opening the matter and the skills of the users potentially being staffed on the matter to calculate the optimal matter score.

In another example embodiment, the optimal matter score can be calculated by determining the time available to a plurality of candidates who each qualify under the same specialty. For example, the optimal matter score can be calculated using the following equation:

$${S}_{OM} = MIV \times UIV \qquad ( Equation 2 )$$

In equation 3, MIV is related to on a percentage of time available during a specific period of time (e.g., 40 hours over two weeks based on an 80 hour workweek), and UIV is a user input value related to a candidate's rating regarding a particular specialty needed for the matter.

In another embodiment, the central server 12 can calculate individual matter scores for specific skills of the user, for example, using the following equations:

$${S}_{I M 1} = MIV 1 \times UIV 1 \qquad ( Equation 3 )$$

$${S}_{I M 2} = MIV 2 \times UIV 2 \qquad ( Equation 4 )$$

$${S}_{IMn} = MIV n \times UIV n \qquad ( Equation 5 )$$

In equations 3 to 5, MIV1 is a matter input value corresponding to a first user input value UIV1, MIV2 is a matter input value corresponding to a second user input value UIV2, and MIVn is a matter input value corresponding to an nth user input value UIVn. The central server 12 can then use one or more of these individual matter scores to calculate an optimal matter score and/or compile a preferred group of possible candidates.

In an embodiment, the central database 12 can access the user terminals 14 of the highest scoring associates at step 214 and/or the historical data from the enterprise database 70 at step 216. In this way, the central database 12 can ensure that the calculated optimal matter scores and/or individual matter scores are accurate based on current information. In an embodiment, the central database 12 can access features of the user terminal 14 such as the GPS device 50, the digital calendar 52, the time entry program 54, and/or other terminal-specific devices which track movements and/or data usage and/or access user input values determined directly at the user terminals 14. For example, the central database 12 can determine a first user input value UIV1 and/or a second user input value UIV2 using the user's location based on GPS device 50 or the user's schedule or availability based on the digital calendar 52. Alternatively or additionally, the central database 12 can access the enterprise database 70 and obtain updated user input values calculated, for example, as previously discussed herein.

At step 218, the central server 12 uses the availability determined at step 208 and the optimal matter scores determined at step 212 to cause the creation of a plurality of optimal candidates who are available to fill the organizational user's matter. Using the information determined at step 208, the central server 12 is able to eliminate candidates that do not meet an absolute bar such as availability in a certain location or over a specified period of time. Using the information determined at step 212, the central server 12 is able to eliminate candidates who may be available but do not have enough experience to fill the matter, who may take too long to complete the matter based on the current schedule, or who are ill-suited based on other factors. The central server 12 is able to further rank the possible candidates based on the optimal matter scores or the individual matter scores. The central database 12 can then transmit the optimal candidates and corresponding scores to the user terminal 14 of the organizational user attempting to open a new matter or fill an old matter.

In an embodiment, the central server 12 can eliminate candidates with the lowest optimal matter scores or individual matter scores, or can eliminate candidates with optimal matter scores or individual matter scores which do not meet a predetermined threshold. The predetermined threshold can be automatically determined by the central server, or can be input by the organizational user (e.g., at step 204). The remaining optimal candidates can then be ranked according to their optimal matter scores or individual matter scores, and can be transmitted to the user terminal 14 of the organizational user.

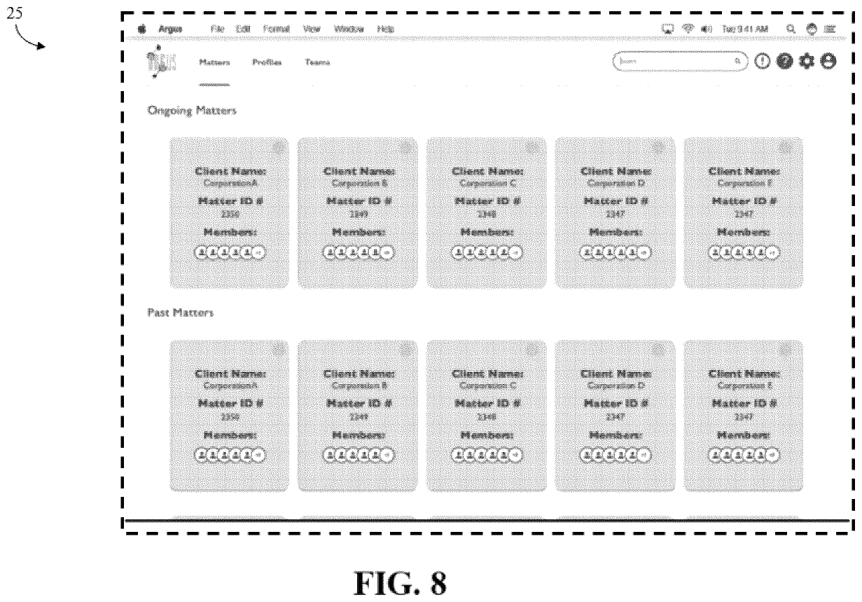

In an embodiment, the user terminal 14 can display the optimal candidates to the organizational user by arranging icons for the optimal candidates according to their fit for the matter being filled. For example, the user terminal 14 can display the icons so that the optimal candidates are ordered on the display 40 (e.g., GUI 25) based on their calculated optimal matter scores and/or individual matter scores. In an embodiment, central server 12 and/or terminal 14 can further determine which of the optimal candidates the organizational user has previously staffed on matters and order the optimal candidates so that icons for familiar candidates are shown first on the display 40. Examples embodiments of adjusting the icons are discussed below using FIGS. 8 to 15. In another embodiment, the icons can be arranged based on the number of matching keywords from matter inputs by the organizational user.

In an embodiment, the user terminal 14 can display the optimal candidates to the organizational user by arranging icons for the optimal candidates according targets or goals for the candidate. For example, the candidates or the organization may wish for the candidates to get experience in specific areas. The optimal candidates can therefore be displayed to the organization user by arranging icons with the intent of prioritizing candidates who need to gain the specific experience needed for the matter position being filled. In another example, the candidates or the organization may wish for the candidates to work a certain number of hours or reach certain billing goals. The optimal candidates can therefore be displayed to the organization user by arranging icons with the intent of prioritizing candidates who need to gain the specific experience needed for the matter position being filled.

At step 220, the user is able to make a selection on the user terminal 14 to fill the matter. In making the selection, the user can view optimal candidates, who can optionally be ranked based on the optimal matter scores and/or the individual matter scores using the user input 34 and/or display 40. In another embodiment, the optimal candidates can be ranked by specialty and/or availability over a specified time period. The organizational user can also view profiles for each of the users on the list. The profiles can include, for example, basic information about the selected candidate, e.g., qualifications, education, areas of expertise, firm history, performance, etc. The profile information can also include an illustration of matters currently assigned to that candidate and their projected durations.

In an embodiment, the organizational user can return to step 204 to adjust the one or more matter inputs and receive a new optimal candidates. The organizational user can choose to do so, for example, if not satisfied with the current optimal candidates. In another embodiment, the organizational user can also view, on the display 40, any candidates which have high optimal matter scores and/or individual matter scores calculated during step 212, but who are unavailable for one or more reason as determined during step 208, such that the organizational user can determine whether certain of the matter inputs can be adjusted to meet the qualifications of an unavailable candidate. In an embodiment, the organizational user can override central server 12 and select a candidate who was determined to be unavailable during step 208.

Once the organizational user has made a selection via the user terminal 14, the method can continue to step 222 where the selected candidate is added to the matter and, in parallel, to step 224 where the selected candidate is contacted (e.g., via email or other communication channel) and asked to confirm his/her ability to be assigned to the matter. If the selected candidate confirms availability, the method can continue to step 226 where, for an existing matter, the selected candidate is added to that matter. Alternatively, if a matter has not been previously created, flow can continue to step 228 where a new matter is created and the selected candidate added thereafter. Once added, the central server 12 can access the digital calendar 50 of the selected candidate and add the current matter, thus decreasing the selected candidate's availability for future matters and/or decreasing the matter input value calculated for that candidate for subsequent matters by other organizational users. By making these changes, the system improves efficiency and processing speeds for the staffing of future matters by other organizational users.

In an embodiment, once a matter has been staffed, central server 12 can generate a quote for the matter based, for example, on the selected candidate's billing rate and/or prior experience. For example, by using data regarding past matters completed by the selected candidate, the central server can calculate and expected amount of time needed to complete the new matter for which the selected candidate was chosen by the organizational user. Using this calculation, central server 12 can then create and/or update a time and/or cost estimate for the organizational user to have the matter completed.

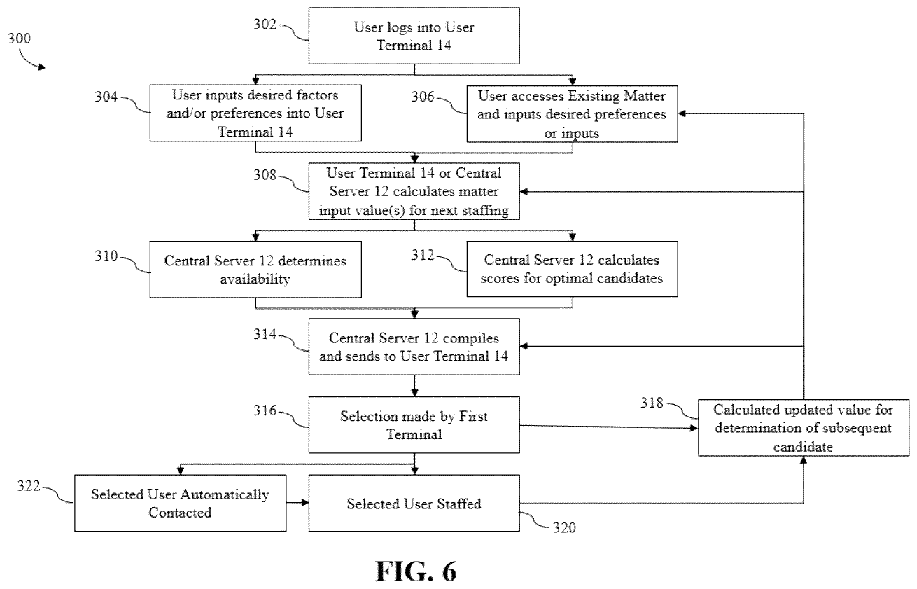

FIG. 6 illustrates another example embodiment of a method 300 for optimizing professional services. Specifically, method 300 enables the optimization of an ideal professional services team with a plurality of users who work well together and/or work together frequently. Some or all of the steps of method 300 can be stored as instructions on the central memory 22 and/or one or more terminal memory 32 and can be executed by the central processor 20 and/or one or more terminal processor 30 in accordance with the respective instructions stored on the central memory 22 and/or one or more terminal memory 32. It should be understood that some of the steps described herein can be reordered or omitted without departing from the spirit or scope of method 300.

At step 302, an organizational user seeking to staff a matter with multiple associates logs into a user terminal 14. The organizational user can be the first user U₁ or the second user U₂ previously discussed herein, or can be a new user. Likewise, the user terminal 14 can be the first terminal 14a or the second terminal 14b previously discussed herein, or can be a new user terminal 14. The user terminal 14 can be, for example, a cellular phone, tablet, personal computer, or other electronic device. The user terminal 14 can have user processing instructions 34 saved on a terminal memory 32, or can communicate with the central server 12 to receive user processing instructions 34 which can be executed by the terminal processor 30. The user processing instructions can include, for example, instructions which enable the user terminal 14 to accept various matter inputs regarding the organizational user's needs for staffing the matter. In an embodiment, the organizational user can be queried to input basic information regarding the new matter, e.g., client, requested representation, opposing parties, nature of the representation, particular roles to be filled in performance of the work for the matter, etc.

At step 304, the organizational user inputs one or more matter inputs into the user terminal 14 using the user input 34 and/or display 40. The matter inputs can include, for example, a type of work desired, a location of work desired, a number of hours desired, a range of billing rates desired, language speaking abilities, and/or other keywords. The one or more matter inputs can also include, for example, weighting factors which allow the user to input preferences and/or weight the matter inputs. For example, the organizational user can require a specific specialty regardless of location, or can require a specific location, number of hours, or certain days available. In an embodiment, the organizational user can also search for candidates for each role or position designated for this matter.

In an embodiment, step 304 involves a law firm partner providing matter inputs concerning specific availability and/or other criteria for multiple associate positions they would like to fill for a given matter. In this case, the availability criteria can be expressed as windows of time needed for different associates to be available, as well as an anticipated total time or percentages of the associate's time that would be required during that window of time. Likewise, the other criteria can be based on any of a number of searchable attributes for associates, e.g., by the associate's title, practice group, office/location, billing rate, language speaking abilities, and/or keywords. In an embodiment, the law firm partner can input a total amount of time needed from multiple associates, and the central server 12 can ensure that the total time is available and accounted for multiple associates as method 300 progresses.

At step 306, the organizational user can access an existing matter and optionally input one or more matter inputs into the user terminal 14 using the user input 34 and/or display 40. The matter inputs can include, for example, a type of work desired, a location of work desired, a number of hours desired, a range of billing rates desired, and/or other keywords. The one or more matter inputs can also include, for example, weighting factors which allow the user to input preferences and/or weight the matter inputs. For example, the organizational user can require a specific specialty regardless of location, or can require a specific location, number of hours, or certain days available. The matter inputs can also include a request for multiple candidates who have worked together in the past.

At step 308, the user terminal 14 and/or the central server 12 calculates matter input values (MIV) using the one or more matter inputs entered at steps 304 and/or 306. The matter input values can be calculated, for example, by taking into account both the type of work desired and the importance of various factors regarding the work. In an example embodiment, one or more matter input value can be calculated based on a percentage of time available during a specific period of time. For example, a matter input value can be calculated as signifying a request for 50% of an associate's time over a specific two-week period (e.g., 40 hours over two weeks based on an 80 hour workweek).

The matter input values can also be calculated in other ways. In another example embodiment, one or more matter input value (MIV) can be calculated such that 0≤MIV≤1. For example, an indispensable element can be calculated as 1, an unimportant element can be calculated as 0, and a preferred or desired but not indispensable element can be calculated to be between 0 and 1. Those of ordinary skill in the art will recognize alternative ways to calculate matter input values and/or alternative scaling that can be used. By calculating matter input values in this manner, the system 10 disclosed herein is able to improve processing speed when determining optimal candidates and reduce storage space for items related to the matter.

In another embodiment, the matter input values can be calculated based on ratings or specific needs regarding practice specialty, current or future locations, preferred working days or hours, current availability, willingness to travel to certain locations, language speaking abilities, and/or other types of information relevant to a specific matter. In an embodiment, a single matter input value can be calculated for each rating or specific need, or multiple matter input values can be calculated for each rating or specific need.

At step 310, the central database 12 determines the availability of a preliminary group of associates appearing to fit the user's desired criteria, for example, by meeting or exceeding the calculated matter input value. In an embodiment, the central server 12 can first compile a preliminary group of candidates which each meet or exceed at least one of the matter inputs inputted by the user at step 204. The central server 12 can compile the preliminary group of candidates, for example, using the matter input values calculated at step 206 by favoring the candidates determined to have the highest corresponding matter input value(s).

In an embodiment, the central database 12 can access the user terminals 14 of the preliminary group of candidates during step 310 to determine each candidate's availability to work on the matter desired by the organizational user. Specifically, the central database 12 can access features of a candidate's user terminal 14 such as the GPS device 50, the digital calendar 52, the time entry program 54, and/or other terminal-specific devices which track movements and/or data usage of the terminal 14. For example, the central database 12 can confirm a candidate's location using the GPS device 50 and/or a user input value calculated from data from the GPS device 50. Likewise, the central database 12 can confirm the candidate's availability over a specific period of time or the candidate's ability to dedicate a specific number of hours over a specific time by accessing the candidate's digital calendar 52 and/or a user input value calculated from data from the candidate's digital calendar 52. The central database 12 can further calculate the candidate's available time using time entry program 54 and/or a user input value calculated from data from the candidate's time entry program 54, for example, by determining how much time the candidate has remaining with a matter currently being performed. For example, if the candidate is currently working on a matter during a specified time period which is expected to take a certain number of hours (e.g., 40 hours), the central database can determine the amount of time already billed to that matter (e.g., 20 hours) and determine the amount of remaining time the user will need to complete that matter (e.g., another 20 hours), thus determining the candidate's availability during that time period. Using the data received from the user terminals 14, the central database 12 can then eliminate one or more candidate of the preliminary group of candidates who cannot satisfy the organizational user's needs for the new matter being staffed, for example, for not meeting or exceeding a calculated matter input value regarding availability.

At step 312, the central database 12 calculates optimal values for the optimal candidates to fill the organizational user's needs for staffing the matter. The optimal values can be calculated, for example, by calculating an optimal matter score based on the candidate's specialty and/or the needs of the user staffing the matter. For example, the central database 12 can calculate an optimal score for each of a plurality of possible candidates, which can include the first user U₁ and other users who have completed the method of 100. In an embodiment, the central processor 20 calculates a plurality of optimal matter scores using one or more of the matter inputs determined at steps 304 and/or 306, the matter input values (MIV's) calculated at step 308, and/or the user input values (UIV's) (e.g., the user input values and/or updated user input values) calculated during the database building method 100. In an embodiment, the central processor 20 can calculate each optimal matter score, for example, using Equations 1 or 2 discussed above. In another embodiment, the central processor 20 can calculate individual matter scores for specific skills of the user, for example, using Equations 3 to 5 above.

In an embodiment, the central database 12 can access the user terminals 14 of the highest scoring associates and/or the historical data from the enterprise database 70 during step 312. In this way, the central database 12 can ensure that the calculated optimal matter scores and/or individual matter scores are accurate based on current information. In an embodiment, the central database 12 can access features of the user terminal 14 such as the GPS device 50, the digital calendar 52, the time entry program 54, and/or other terminal-specific devices which track movements and/or data usage and/or access user input values determined directly at the user terminals 14. For example, the central database 12 can determine a first user input value UIV1 and/or a second user input value UIV2 using the user's location based on GPS device 50 or the user's schedule or availability based on the digital calendar 52. Alternatively or additionally, the central database 12 can access the enterprise database 70 and obtain updated user input values calculated, for example, as previously discussed herein.

At step 314, the central server 12 uses the availability determined at step 310 and the optimal matter scores determined at step 312 to cause creation of optimal candidates who are available to fill one of a plurality of positions for the organizational user's matter. Using the information determined at step 310, the central server 12 is able to eliminate candidates that do not meet an absolute bar such as availability in a certain location or over a specified period of time. Using the information determined at step 312, the central server 12 is able to eliminate candidates who may be available but do not have enough experience to fill the matter, who may take too long to complete the matter based on the current schedule, or who are ill-suited based on other factors. The central server 12 is able to further rank the possible candidates based on the optimal matter scores and/or the individual matter scores. The central database 12 can then transmit the optimal candidates and corresponding scores to the user terminal 14 of the organizational user attempting to open a new matter or fill an old matter.

In an embodiment, the central server 12 can eliminate candidates with the lowest optimal matter scores or individual matter scores, or can eliminate candidates with optimal matter scores or individual matter scores which do not meet a predetermined threshold. The predetermined threshold can be automatically determined by the central server, or can be input by the organization user (e.g., at steps 304 and/or 306). The remaining users can then be ranked according to their optimal matter scores or individual matter scores, and the list can be transmitted to the user terminal 14 of the organizational user.

In an embodiment, the user terminal 14 can display the optimal candidates to the organizational user by arranging icons for the optimal candidates according to their fit for the matter being filled. For example, the user terminal 14 can display the icons so that the optimal candidates are ordered on the display 40 (e.g., GUI 25) based on their calculated optimal matter scores and/or individual matter scores. In an embodiment, central server 12 and/or terminal 14 can further determine which of the optimal candidates the organizational user has previously staffed on matters and order the optimal candidates so that icons for familiar candidates are shown first on the display 40. Example embodiments of adjusting the icons are discussed below using FIGS. 8 to 15. In another embodiment, the user terminal 14 can display the optimal candidates to the organizational user by arranging icons for the optimal candidates according targets or goals for the candidate, as explained above.

At step 316, the organizational user is able, on the user terminal 14, to select a first candidate to fill one of a plurality of positions for the matter. In making the selection, the organizational user can view possible candidates, who can optionally be ranked based on the optimal matter scores and/or the individual matter scores, using the user input 34 and/or display 40. In another embodiment, the possible candidates can be ranked by specialty and/or availability over a specified time period. The organizational user can also view profiles for each of the candidates on the list. The profiles can include, for example, basic information about the selected candidate, e.g., qualifications, education, areas of expertise, firm history, performance, etc. The profile information can also include an illustration of matters currently assigned to that candidate and their projected durations.

Once the user has made a selection of a first candidate via the user terminal 14, the method can continue to step 320 where the selected first candidate is added to the matter and, in parallel, to step 322 where the selected first candidate is contacted (e.g., via email or other communication channel) and asked to confirm his/her ability to be assigned to the matter. If the selected first candidate confirms availability, the method can continue to step 318 where the organizational user can begin the process of selecting a second candidate to staff the matter. In an embodiment, the central server 12 can access the digital calendar 50 of the first candidate and add the current matter, thus decreasing the first candidate's availability for future matters and/or decreasing the matter input value calculated for the first candidate for subsequent matters by other organizational users. By making these changes, the system improves efficiency and processing speeds for the staffing of future matters by other organizational users.

At step 318, the central server 12 calculates an updated value based on the first candidate who has already been selected. In an embodiment, the updated value can be an updated matter input value based on the first candidate's availability to work during a previous time period. For example, if the organizational user requires 50% of an associate's time over a specific two-week period, and the first candidate can provide 60% of their time over that specified period, then the central server can calculate the updated value so that an updated matter input value for a second candidate is recalculated to 40%. In another embodiment, the updated value can be an updated matter input value based on the first candidate's specialty. For example, if the organizational user requires multiple specialties, and the first candidate can provide only one of those specialties, then the central server can recalculate the updated value so that an updated matter input for a second candidate requires one of the remaining specialties. In another embodiment, the updated value can be an updated matter input value based on the first candidate's location. For example, if the organizational user requires associates in multiple locations, and the first candidate can provide only one of those locations, then the central server 12 can recalculate the updated value so that an updated matter input for a second candidate requires the second candidate to be located in one of the other locations.

In an embodiment, method 300 can proceed from step 318 to step 306, wherein the organization user can be enabled to update the one or more matter inputs for a second candidate after selection of the first candidate. Based on the abilities of the selected first candidate, for example, the organizational user may decide that the requirements for the second candidate have changed. The method 300 can then proceed through the rest of the steps and can be repeated for as many candidates as are required to fill a matter.

In another embodiment, method 300 can proceed from step 318 to step 308, wherein the user terminal 14 and/or central server 12 can automatically recalculate one or more matter input value for the second candidate using the updated value from step 318. The method 300 can then proceed through the rest of the steps and can be repeated for as many candidates as are required to fill a matter.

In yet another embodiment, method 300 can proceed from step 318 to step 314, wherein the user terminal 14 and/or central server 12 can narrow the previously determined optimal candidates using the updated value from step 318. In an embodiment, the icons on the display 40 can be automatically reordered based on the remaining optimal candidates who have previously worked with the selected candidate. The method 300 can then proceed through the rest of the steps and can be repeated for as many candidates as are required to fill a matter.

In an embodiment, once a matter has been staffed, central server 12 can generate a quote for the matter based, for example, on all of the selected candidates' billing rates and/or prior experience. For example, by using data regarding past matters completed by the selected candidates, the central server can calculate and expected amount of time needed to complete the new matter for which the selected candidates were chosen by the organizational user. Using this calculation, central server 12 can then create and/or update a time and/or cost estimate for the organizational user to have the new matter completed.

FIG. 7 illustrates an example embodiment of a method 400 for reviewing/editing existing matters for use with the earlier-described methods. Some or all of the steps of method 400 can be stored as instructions on the central memory 22 and/or one or more terminal memory 32 and can be executed by the central processor 20 and/or one or more terminal processor 30 in accordance with the respective instructions stored on the central memory 22 and/or one or more terminal memory 32. It should be understood that some of the steps described herein can be reordered or omitted without departing from the spirit or scope of method 400.

Beginning at step 402, a user can select from any ongoing or completed matters. If completed matters are selected, flow continues to step 404 where the user is permitted to view matters according to the members used to staff each of those matters or by client. For example, the user could elect to see all of the completed matters worked on by a given attorney. Alternatively, the user could review all completed matters for a given client (which matters can include selectable listings of attorneys that worked on those matters).

If the user selects ongoing matters, the method continues to step 406 where the user can indicate whether he/she would like to view or edit such matters. If the user elects to view ongoing matters, the method continues to step 408 where the user further indicates whether to view the ongoing matters by client or teams. If by clients, the method continues to step 414 where all ongoing matters, by client, that the current user is associated with are displayed. Alternatively, if viewing by team is indicated, all matters for any teams of which this user is a member are displayed at step 410. At step 412, individual team members included in the display at block 410 can be selected for further viewing by profile.

If, at step 406, the user instead chooses to edit an ongoing matter, the method continues to step 416. It is noted that matter editing privileges will generally be restricted to partners and/or the attorney that created a given matter (in the event that attorneys below the partner level are permitted to create new matters in the firm's databases). Regardless, at step 416, the user can indicate whether they would like to edit membership of the team or a particular phase of the ongoing matter. If the former, the method continues to step 418 where the user is able to search for attorneys and revise team membership in accordance with methods 200 and/or 300 as described herein. Thereafter, the method continues to step 420 where the changes to the team membership for a give matter are confirmed. Alternatively, if the user elects to edit a phase for an ongoing matter, the method continues to step 422 where, in the illustrated embodiment, the user is permitted to add a new phase to the matter (e.g., file a notice of appeal in a litigation matter) or remove a previously designated phase (e.g., a further round of negotiations for a transactional matter), for example, by performing method 200 or method 300 as discussed herein.

FIGS. 8 to 11 illustrate various examples of a GUI 25 that can be presented to an organizational user on a display 40. FIG. 8 illustrates an example embodiment of a GUI 25 that can be presented to an organizational user upon entry into the above-described system. Through this interface, the organizational user can view a collection of matters, both ongoing and completed, with options to click on each matter to view relevant information and assigned associates. In the illustrated embodiment, each of the illustrated matters includes a client name, information identifying the particular matter for that client, and icons corresponding to each associate assigned to the particular matter. As further shown, a search bar can be provided to permit partners to search for associates or to view the various subject matter groups to which they belong. From here the organizational can choose to view their own profile as well.

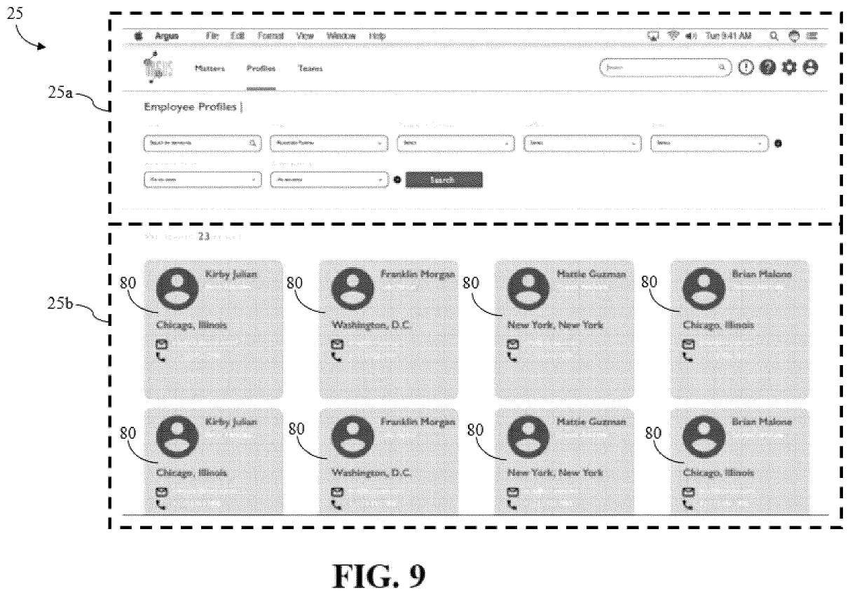

FIG. 9 illustrates an example embodiment of a GUI 25 in accordance with the methods of the present disclosure. As shown, a first portion 25a of the GUI 25 can enable the organizational user to use pre-selected filtering options or add their own (including but not limited to an availability time range, office, practice group, title, rate, and availability) to search for candidates. Additionally, the organizational user can use the search bar to search by name for a particular candidate that they might have in mind or search for a collection of associates using the aforementioned criteria. Upon selecting the desired criteria, the organizational user can select the “Search” button and thereafter be provided with a list of candidates using the methods discussed herein, which the organizational user can select from to view an individual candidate's profile, additional relevant skills, analytics, etc. In an embodiment, the first portion 25a can enable an organizational user to perform steps 204, 304 and/or 306 as described herein.

In the illustrated example, a second portion 25b of the GUI 25 can display a plurality of icons 80 associated with optimal candidates which have been determined using the methods of the present disclosure (e.g., steps 218, 220, 314 and/or 316). Here, each icon 80 includes an optimal candidate's name, title and contact information, thereby permitting the organizational user to immediately contact that optimal candidate if desired. In an embodiment, the GUI 25 can display the optimal candidates to the organizational user by arranging the icons 80 for the optimal candidates according to their fit for the matter being filled. For example, the user terminal 14 can display the icons 80 so that the optimal candidates are ordered on the GUI 25 based on their calculated optimal matter scores and/or individual matter scores. In an embodiment, the central server 12 and/or the terminal 14 can further determine which of the optimal candidates the organizational user has previously staffed on matters and order the optimal candidates so that icons for familiar candidates who have been previously staffed the most times are shown first on the GUI 25.

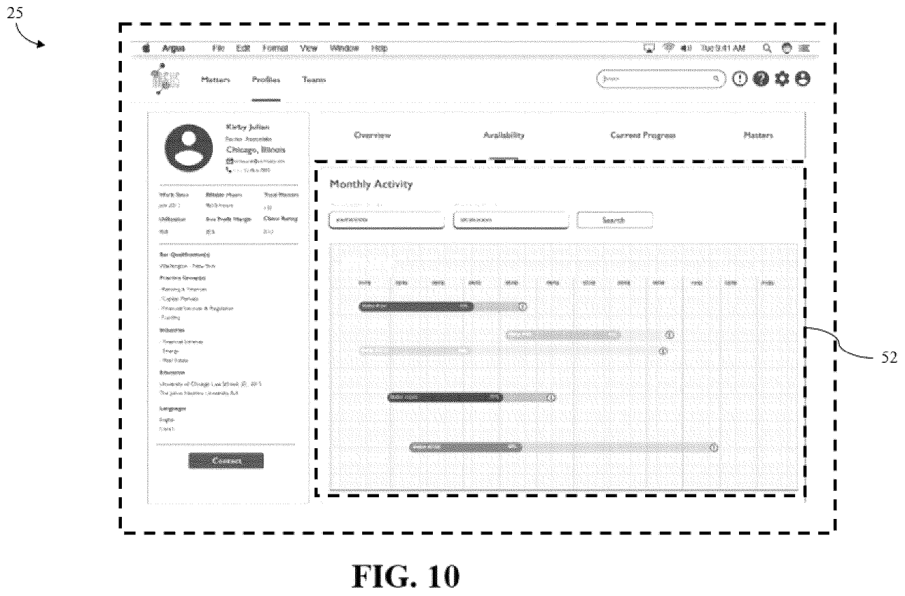

FIG. 10 illustrates an example embodiment of the GUI 25 when an organizational user selects an optimal candidate (e.g., by selecting an icon 80 from the GUI 25 shown in FIG. 9) and is able to view a representation of the optimal candidate's digital calendar 52. As illustrated, the GUI 25 can present relevant information about the attorney, as shown on the left side of FIG. 10. Further, the digital calendar 52 can include a Gantt chart of the matters (five shown in the illustrated example) to which the selected optimal candidate has already been assigned. As shown, the Gantt chart can illustrate the anticipated duration of each matter and further highlights the percentage of the completion of each matter, for example, based on user inputs by the user via the time entry program 54. Additionally, the organizational user can click on the other tabs to view individual matters in more detail and determine their availability. In an embodiment, this user interface can also include an option to contact the optimal candidate (“Contact” button). In another embodiment, the central server 12 can access the user terminal associated with the optimal candidate and update the digital calendar 52 in real time.

In an embodiment, a user input value can be calculated from a digital calendar 52 such as that shown in FIG. 10. Here, the user can make one or more user input related to the calendar, for example, by accepting a new matter assignment or adding other events to the calendar, or by inputting time which relates to a portion of the calendar. The user input value can be calculated, for example, as a percentage of that user's time available over a specified period or a total number of hours available over the specified period. The user input value can also be calculated based on the amount of time the user has already spent on a pending matter.

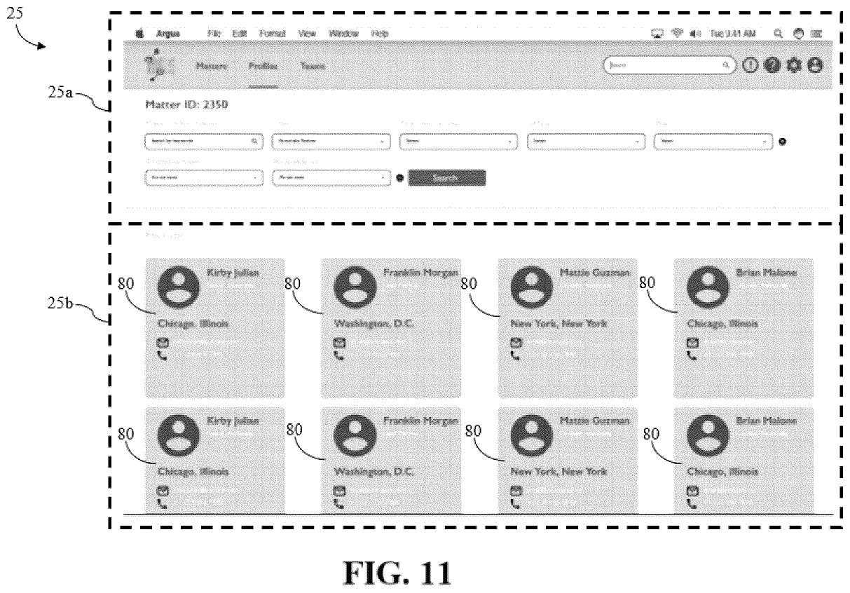

FIG. 11 illustrates another example embodiment of a GUI 25 in accordance with the methods of the present disclosure. While the first portion 25a of the GUI 25 is similar to FIG. 9, the search option provided by this user interface is specific to positions that will be required to complete the matter. Once an organization user has assigned relevant positions to a matter, they can then assign an associate to that position using the search function as described previously. Similar to above, the GUI 25 at second portion 25b can display the optimal candidates to the organizational user by arranging the icons 80 for the optimal candidates according to their fit for the matter being filled. For example, the user terminal 14 can display the icons 80 so that the optimal candidates are ordered on the GUI 25 based on their calculated optimal matter scores and/or individual matter scores. In an embodiment, the central server 12 and/or the terminal 14 can further determine which of the optimal candidates the organizational user has previously staffed on matters and order the optimal candidates so that icons for familiar candidates who have been previously staffed the most times are shown first on the GUI 25.

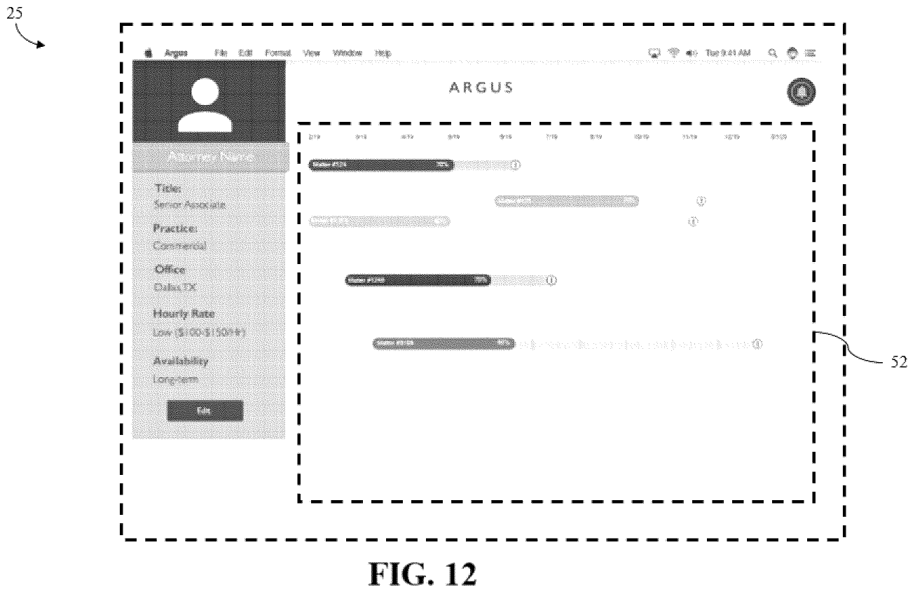

FIGS. 12 to 15 illustrate various example embodiments of the GUI 25 that can be presented to candidates. FIG. 12 illustrates an example embodiment of a GUI 25 presented to a candidate upon entry into the above-described system. Through this interface, the candidate is presented with a digital calendar 52 substantially similar to that shown in FIG. 10, i.e., illustrating the candidate's on-going matters along with an indication of each matter's percentage of completion. The percentage of completion can be automatically updated, for example, as the candidate inputs time entries into the time entry program 54. Each of the illustrated matters is selectable such that selection of any given matter will provide a further GUI 25 that includes more detailed information for the selected matter. As further shown in FIG. 12, the GUI 25 can also include the associate's personal information such as, in this example, title, practice, office, rate, and availability.

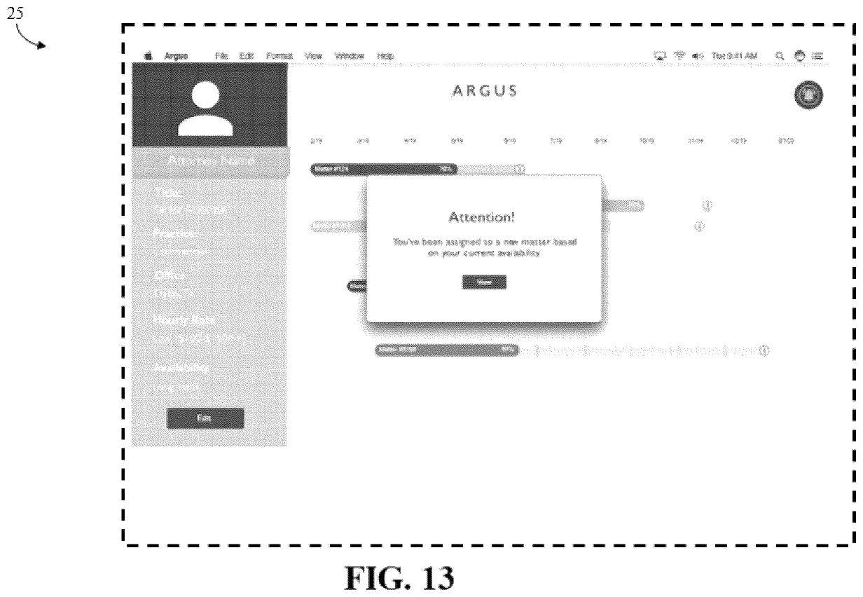

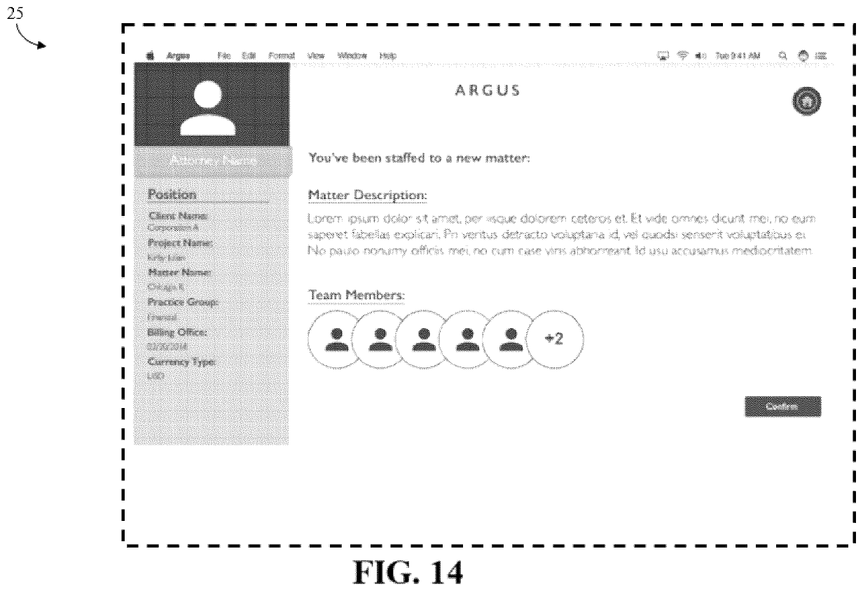

As described above, when candidate is added to a matter by an organizational user, the candidate can receive an email requesting confirmation of same. However, in an alternative embodiment, the GUI 25 as shown in FIG. 13 can be used for this purpose. In this case, when the candidate views his or her ongoing matters using a user terminal 14, the display 40 can be updated with the illustrated pop-up window (or similar mechanism) stating that, based on their current availability/workload, they are being staffed to a new matter. As further shown, the candidate can select a “View” button that permits them to see more information, an example of which is illustrated in FIG. 14, about the new matter and to confirm his/her ability to work on the matter. In addition to a description of the matter and relevant particulars (shown on the left) for the assigned position or role, icons are also provided in FIG. 14 illustrating other team members, which can be selected for review by the candidate. Upon reviewing the new matter, the candidate can select the “Confirm” button.

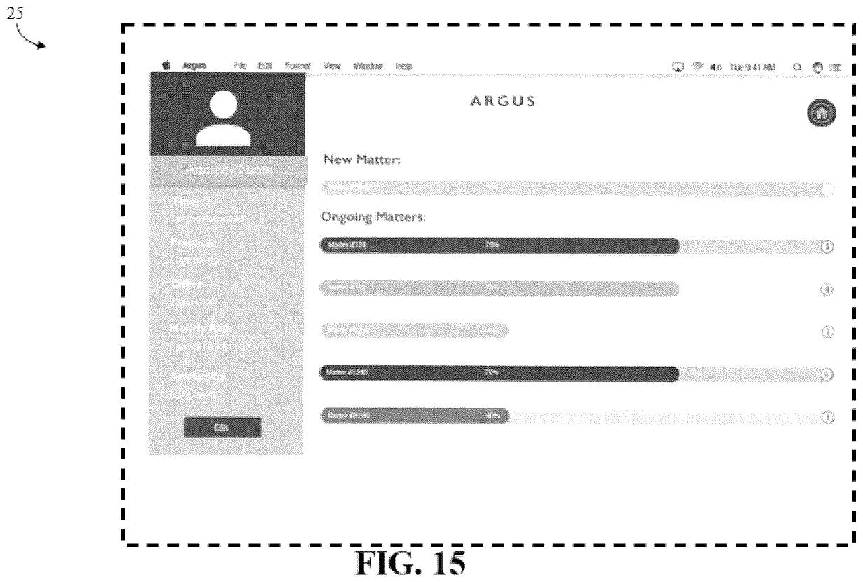

Upon selection of the “Confirm” button, the GUI 25 of FIG. 15 is presented to the candidate as showing the new matter along with a list of progress bars of their other ongoing matters. Additionally, the digital calendar 42 shown in FIG. 12 can be updated to show how this new matter will fit into the associate's timeline/schedule. The updates can further be reported to central server 12 to be used in subsequent staffing methods as described herein.

The embodiments described herein provide improved systems and methods for optimizing the staffing of professional services resources. By condensing the data using the various calculations discussed herein, processing speeds can be increased and memory space can be conserved. Particularly for large organizations requiring matters to be staffed from amongst hundreds or thousands of candidates, the systems and methods enable reliable and optimally suited candidates to be staffed in a relatively short amount of time, with processing speeds increased in comparison for searching for or contacting candidates individually. It should be understood that various changes and modifications to the system and method described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method of rearranging icons on a graphical user interface of a computer system, the method comprising:
arranging a plurality of icons corresponding to a plurality of candidates on the graphical user interface;
receiving a selection of a first candidate of the plurality of candidates from a user using the graphical user interface;
determining, by a processor, an availability of the first candidate over a predetermined time period; and
automatically rearranging the plurality of icons on the graphical user interface for selection of a second candidate based at least in part of the availability of the first candidate.

2. The method of claim 1, comprising
eliminating at least one of the icons upon selection of the first candidate based on a GPS location of a user terminal of at least one candidate corresponding to the at least one of the icons.

3. The method of claim 1, comprising
eliminating at least one of the icons upon selection of the first candidate based on at least one digital calendar entry of at least one candidate corresponding to the at least one of the icons.

4. The method of claim 1, comprising
eliminating at least one of the icons upon selection of the first candidate based on a practice specialty of at least one candidate corresponding to the at least one of the icons.

5. The method of claim 1, comprising
automatically rearranging the plurality of icons on the graphical user interface based at least in part on data usage of user terminals corresponding to multiple of the plurality of candidates.

6. The method of claim 1, comprising
automatically rearranging the plurality of icons on the graphical user interface based at least in part on tracked movements of user terminals corresponding to multiple of the plurality of candidates.

7. The method of claim 1, comprising
compiling the plurality of candidates based on at least one of geographic location, practice specialty and availability.

8. The method of claim 1, comprising
automatically transmitting a notification to the first candidate up selection of the first candidate on the graphical user interface, and
automatically rearranging the plurality of users on the graphical user interface upon confirmation of the notification by the first candidate.

9. The method of claim 1, comprising
generating the graphical user interface via an application downloaded to a user terminal.

10. The method of claim 1, comprising
automatically placing an entry in a digital calendar associated with the first candidate upon selection of the first candidate.

11. The method of claim 1, wherein
determining the availability of the first candidate includes accessing a time entry software program containing time entries related to a plurality of existing matters being worked on by the plurality of candidates.

12. The method of claim 1, wherein
determining the availability of the first candidate includes accessing a digital calendar associated with the first candidate.

13. The method of claim 1, comprising
automatically rearranging the plurality of icons on the graphical user interface based at least in part on candidates having previously worked with the selected first candidate.

14. A method of designing a time entry software system, the method comprising:
configuring a time entry software program to receive time entry inputs for a plurality of existing matters from a plurality of associates;
designing a software wrapper around the time entry software program that is launched when the time entry software program is launched by an associate, the software wrapper requiring the associate to indicate availability over a future time period and prohibiting the associate from entering the time entry inputs until the associate has indicated availability over the future time period;
receiving an indication of the availability of the associate over the future time period via the software wrapper;
receiving one or more time entry input from the associate via the time entry software program after indicating the availability over the future time period via the software wrapper; and
positioning an icon for the associate on a graphical user interface based on both the indication of availability via the software wrapper and the time entry input via the time entry software program.

15. The method of claim 14, comprising
positioning the icon for the associate on the graphical user interface based on the indication of availability via the software wrapper, the time entry input via the time entry software program, and at least one entry in a digital calendar for the associate.

16. The method of claim 14, comprising
positioning the icon amongst a plurality of icons on the graphical user interface.

17. The method of claim 16, comprising
automatically rearranging the plurality of icons on the graphical user interface upon selection of a first icon of the plurality of icons.

18. The method of claim 16, comprising
eliminating the icon from the graphical user interface upon selection of a first icon of the plurality of icons.

19. The method of claim 16, comprising
automatically rearranging the plurality of icons on the graphical user interface upon selection of the icon.

20. The method of claim 14, comprising
designing the software wrapper to launch on at least a weekly basis.
